(19) United States
(12) Patent Application Publication
(10) Pub. No.: US 2006/0233394 A1
(43) Pub. Date: Oct. 19, 2006

(54) Audio interface device for public address systems

(76) Inventor: John E. Lehmkuhl, Payette, ID (US)

Correspondence Address: PEDERSEN & COMPANY, PLLC, P.O. BOX 2666, BOISE, ID, 83701, US

(21) Appl. No.: 10/544,535

(22) PCT Filed: Feb. 4, 2004
(86) PCT No.: PCT/US04/03234

§ 371 Date: Jun. 9, 2006

(30) Foreign Application Priority Data
Feb. 4, 2003 (US) 10359341

(51) Int. Cl. H04B 1/00

(52) U.S. Cl. 381/119

(57) ABSTRACT

An audio interface device may include an audio adapter circuit having some properties and capabilities similar to those of a standard direct-box, but preferably with additional features such as adaptation to allow high-impedance stereo headphones to be connected and a switch that turns the signal to the exterior sound system on/off without interrupting sound to the headphones. The device may be housed in a rugged chassis and may include a locking cover and/or mounting structure. Optionally, the device may be incorporated into audio mixing equipment A preferred mixer-direct-box embodiment may mix multiple audio inputs into one or more outputs, and may comprise an audio input connection from an external source that provides a direct audio signal being provided to a first external output, an internal mixer input that routes said direct audio signal internally to the mixer electronic circuit portion of the device, an audio transformer that converts the direct audio signal from a high-impedance signal into a low-impedance audio signal provided to a second external output, and a switch allowing the direct audio signal to be connected and disconnected from the internal mixer input and from the audio transformer.

### BACKGROUND OF THE INVENTION

1. Field of the Invention

This invention relates generally to audio devices and more particularly to improved apparatus and electronic circuitry for “direct boxes” used to convert unbalanced, high impedance signals into balanced, low impedance signals for audio devices, and incorporation of such apparatus and circuitry into audio mixing equipment.

2. Related Art

Most audio producing devices, such as computers, cassette tape players, and personal electronic players, output an unbalanced, high impedance electrical signal. Such signals are vulnerable to electrical interference and cannot be sent over a long transmission line without serious deterioration in signal quality. Converting the unbalanced, high impedance signal into a balanced, low impedance signal can correct this problem with a device known as a “direct box.” This conversion is also often a necessity as many amplifiers and speakers are designed for a balanced, low impedance signal.

An example of such a device is disclosed by Kampes (U.S. Pat. No. 4,737,735). This device uses a non-inverting amplifier and voltage follower circuit. Unlike the present invention, it relies upon active electronic components in order to function.

Numerous direct boxes are available commercially. Typical of these is the Rolls DB-25. It is a passive device that converts an unbalanced, high-impedance signal into a balanced, low-impedance signal and vice-versa. Unlike the present invention, it cannot provide conversion of two stereo input signals into a single, summed and balanced monaural output signal. Nor does the Rolls DB-25 provide a stereo headphone output or a shut-off switch, as do preferred embodiments of the present invention.

Another related direct box is the pcDI Stereo Direct Box manufactured by Whirlwind Music Distributing, Inc. of Rochester, N.Y. It features two input connector jacks, but has no monaural output or headphone capability no shut-off switch, and no cover, as do preferred embodiments of the present invention.

The novel features of the present invention dramatically increase the usefulness in courtrooms, public address, and other presentation venues. The invented direct box may also be embedded into existing audio circuitry, such as into audio mixer technology, which further increases the usefulness and benefits to these presentation venues. No other such devices have been found that incorporate the features and benefits of the present invention in such a way as to provide such a high level of utility as described in the following specification.

### SUMMARY OF THE INVENTION

The present invention comprises an audio interface device, which may also be called a “direct box” due to its sharing some common features with devices typically known in industry by that name. The particular features of this invention allow stereo high-impedance headphones to faithfully reproduce stereo input signals, while at the same time providing a monaural, balanced, low-impedance output to an external sound system. The preferred direct box embodiment may have the ability to convert a high impedance signal into a low impedance signal and may include, or cooperate with, a first output signal and a second output signal, and a switch allowing the first output signal to be connected or disconnected without interrupting the second signal. Preferably, therefore, the invented audio interface device features a disconnect switch that turns the signal to the external sound system on and off without interrupting the sound to the headphones.

In an especially-preferred embodiment of the invention, a direct box circuit according to embodiments of the invention is combined with a mixer circuit that has the ability to mix multiple audio inputs into one or more outputs. The direct box circuit may comprise: an audio input connection from an external source that provides a direct audio signal, wherein said direct audio signal is provided to a first external output; an internal mixer input that routes said direct audio signal internally to the mixer electronic circuit; and an audio transformer that converts said direct audio signal from a high-impedance signal into a low-impedance audio signal provided to a second external output. The direct box circuit may further comprise a switch allowing said direct audio signal to be connected or disconnected from said internal mixer input and from said audio transformer.

Another aspect of the present invention may be the incorporation of another output signal that is unbalanced and is presented to a jack-type connector. This output signal can also be connected or disconnected from the playback input audio signal, thereby allowing for previewing of audio content before being presented as public address or recording content. This unbalanced output signal is typically fed to a set of amplified speakers for room listening purposes, such as multi-media speakers on a court clerk's desk.

The features of the aforementioned embodiments, plus other embodiments, aspects, advantages and features of the present invention will be set forth in part in the description, and in part will come to those skilled in the art by reference to the following description of the invention and referenced drawings, or by practice of the invention.

### BRIEF DESCRIPTION OF THE DRAWINGS

FIG. 1 is a schematic diagram of circuitry contained in one embodiment of the present invention.

FIG. 2A is a right-side view of the outside case and controls of the embodiment of FIG. 1.

FIG. 2B is a left-side view of the outside case and controls of the embodiment of FIGS. 1 and 2A.

FIG. 2C is a top view of the outside case and controls of the embodiment of FIGS. 1, 2A 2B with the cover removed to show the controls.

FIG. 3A is a front view of the outside case of the embodiment of FIGS. 1 and 2, with the cover secured over the controls located on the top.

FIG. 3B is a front view of the outside case of the embodiment of FIGS. 1-3A, with the cover pivoted away from the controls located on the top of the chassis.

FIG. 4 is a schematic block diagram of one embodiment of a mixer circuit for an especially preferred embodiment of the invented Mixer-Direct-Box Device.

FIG. 5A depicts one embodiment of a front panel of the especially preferred embodiment of the Mixer-Direct-Box Device Chassis.

FIG. 5B depicts one embodiment of a rear panel of the especially preferred embodiment of the Mixer-Direct-Box Device Chassis.

FIG. 6 is a schematic block diagram depicting the signal paths and external connections of one embodiment of an installed system utilizing an especially preferred embodiment of the Mixer-Direct-Box Device.

### DETAILED DESCRIPTION OF THE INVENTION

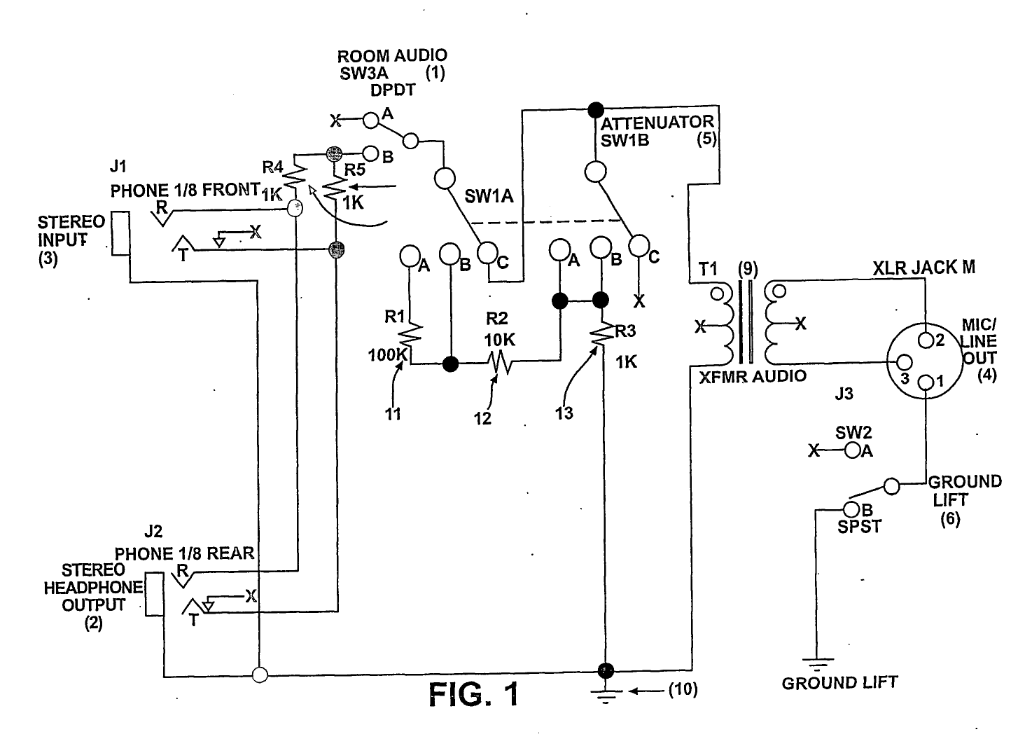

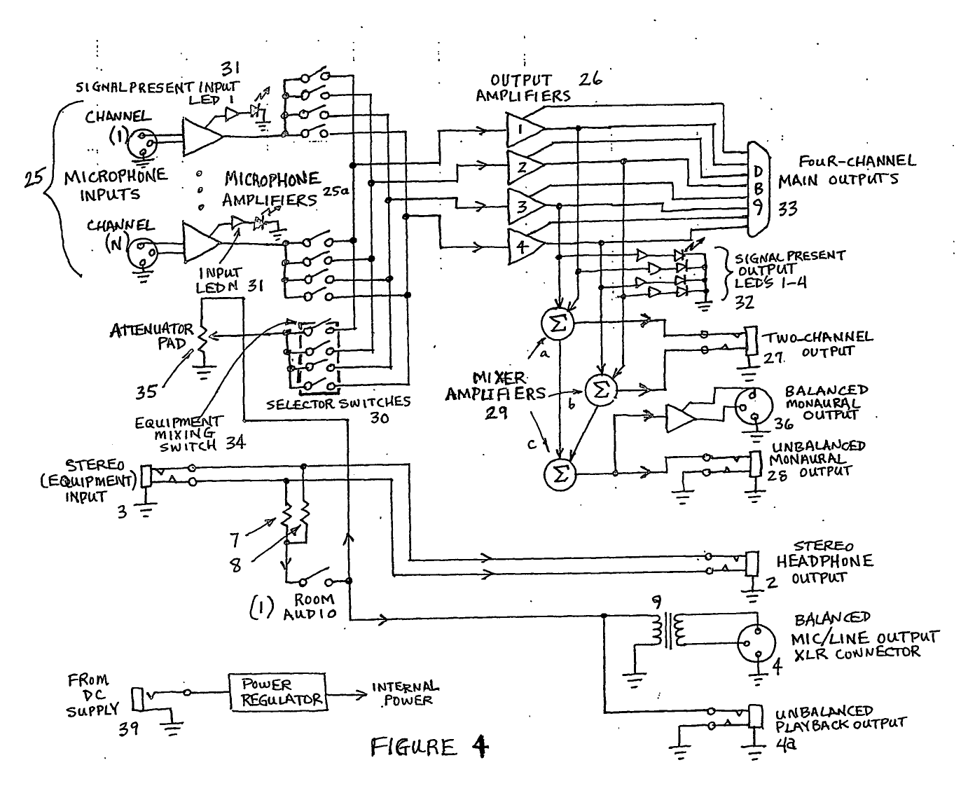

Referring to the Figures, there are shown several, but not the only, embodiments of the invention. In FIGS. 1-3, there is shown an embodiment of the invented audio adapter circuit device. In FIGS. 4-6, there are shown embodiments of the invention that include the invented audio adapter circuit in cooperation with, and preferably housed with, mixer electronic circuitry and hardware.

Audio Adapter Circuitry and Direct Box

Embodiments of the invented audio adapter circuit are preferably placed in a rugged chassis, and are known as a “direct box”, developed to answer many previously-unanswered needs of courtrooms and convention centers. Court personnel making electronic recordings of court proceedings typically listen to the audio being recorded on a ½ second delay to insure that the audio signal is being received by the recording equipment. Embodiments of the invented audio adapter circuit may include a standard headphone jack with a constant, unattenuated audio output.

Often, it is necessary to playback earlier proceedings in a court, conference, or other presentation venue. Until the present invention, there has been no convenient way to play the audio recording directly back over the courtroom's speaker system. The invented audio adapter circuit creates a direct and high-quality connection between the courtroom's recording and playback device and the public address system. By making use of this circuit and “direct box”, the court reporter is able to listen to the sounds being broadcast over the courtroom's sound systems and simultaneously recorded, whether live proceedings or earlier recorded proceedings. The invention allows the user to continuously record court proceedings while also replaying earlier proceedings. The preferred embodiment of the audio adapter circuit includes a second, low impedance output signal to the courtroom's audio system that may be turned on as needed to replay earlier recorded proceedings.

Convention centers typically have the capability to project video presentations from a computer, but cannot connect directly provide digital audio recordings that are included in the presentation. The invented audio adapter circuit/direct box allows the user to connect a computer, cassette record/playback device, or other personal audio device to any microphone outlet by way of a standard XLR mic/line connector mounted on the chassis of the present invention. Also, the preferred embodiments allows the presenter to listen to his audio recording and check that it is correct, without having that audio broadcast over the room's audio system.

FIG. 1 is a schematic diagram of the circuitry contained in the preferred embodiment of the invented direct box.

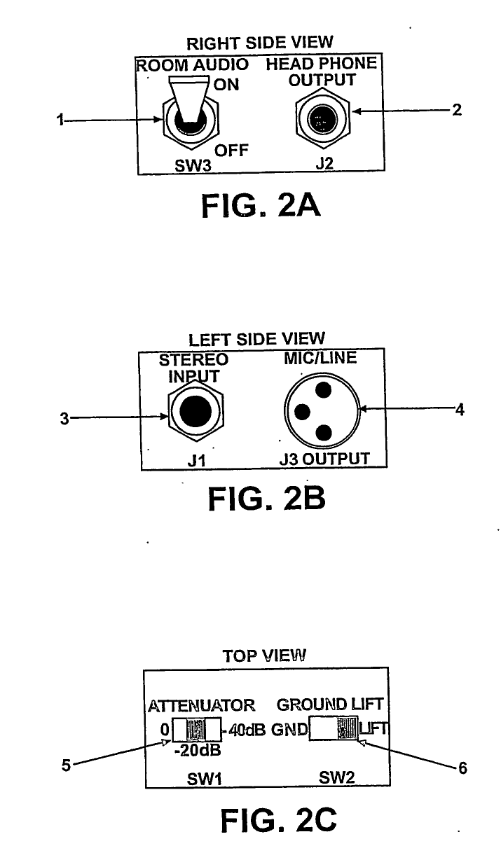

FIG. 2A is a right-side view of the outside case and controls of the preferred embodiment of the present invention. It features a two-position toggle-switch SW3 1 that, when switched to the on position, allows the input signal to be passed through a balancing transformer to the mic/line output, which is typically used as the signal source in a room sound system. When switched to the off position, toggle switch SW3 1 disconnects the input signal from the XLR Mic/Line Output connector. Headphone output connector J2 2 provides a stereo output for the use of standard headphones. In the preferred embodiment, this stereo output plug is a standard 3.5 mm size.

Optionally, there may also be another stereo output plug (not shown in FIG. 2b, but optionally placed on the outside case shown in FIG. 2A) that provides an unbalanced signal that is also switched by toggle switch SW3 1. This unbalanced output may be provided to a set of speakers, such as a set of amplified multi-media speakers, for example, for a court clerk's desk or for a smaller venue that does not have a larger public address system.

FIG. 2B is a left-side view of the outside case and controls of the preferred embodiment of the direct box of the present invention. On this panel face of the chassis, Stereo Input connector J1 3 also accepts a standard 3.5 mm sized stereo jack, and is the main signal input connection. Next to the main input connection the industry-standard XLR-type Mic/Line output connector J3 4 is located. Its three terminals connect to a balanced driver transformer and to chassis ground.

FIG. 2C is a top view of the outside case and controls of the preferred embodiment of the direct box of the present invention. The three-position switch, SW1 5 allows the setting of three different attenuation levels for the output signal; 0 dB, −20 dB, and −40 dB. Two-position switch, SW2 6 allows for isolation of the Mic/Line Output connector 4 from chassis ground. In the GND position, the ground pin of the Mic/Line Output connector 4 is connected to the chassis ground, and in the LIFT position, it is isolated from chassis ground.

Referring again to FIG. 1, the input signal would be connected on the left side and flow to the right. Stereo Input connector J1 3 Headphone output connector J2 2 each have three contacts; a grounding sleeve, a tip and a ring, (the industry standard Sleeve, Tip and Ring terminals). Tip and Ring connect the right and left channels between the two connectors directly while each Sleeve is connected to the chassis ground 10. Summing resistors R4 and R5 7 and 8 combine the left and right stereo signals into a single audio signal which connects to pole B of Room Audio switch SW3 1.

Room Audio switch SW3 1, when switched to the off position, disconnects the input signal from transformer T1 9 and Mic/Line Output connector 4. When switch SW3 1 is closed the audio signal is passed through Attenuator switch SW1 5. The function of Attenuator switch SW1 5 functions as follows:

In position A, the signal passes through attenuation resistors R1 11 and R2 12, with attenuation resistor R3 13 shunting signal energy to ground. This combination provides −40 dB of attenuation.

In position B, the signal passes through attenuation resistors R2 12, with attenuation resistor R3 13 shunting signal energy to ground. This combination provides −20 dB of attenuation.

In position C, the signal passes directly through to transformer T1 9 with zero dB of attenuation.

On the primary (left-side) of transformer T1 9, the audio signal is referenced to chassis ground 10, while both output pins on the secondary (right-side) of provide isolated output signals to Mic/Line Output connector 4.

Again, two-position switch, SW2 6 allows for isolation of the Mic/Line Output connector 4 from chassis ground. In the GND position (B), the Ground pin (pin 1) of the Mic/Line Output connector 4 is connected to the chassis ground 10, and in the LIFT position, it is isolated from chassis ground 10.

The nominal frequency response of the transformer T1 9 is 25 Hz to 20 kHz, +0 dB, −3 dB. The insertion loss of the present invention is less than 0.5 dB. Its nominal output impedance is 600 ohms.

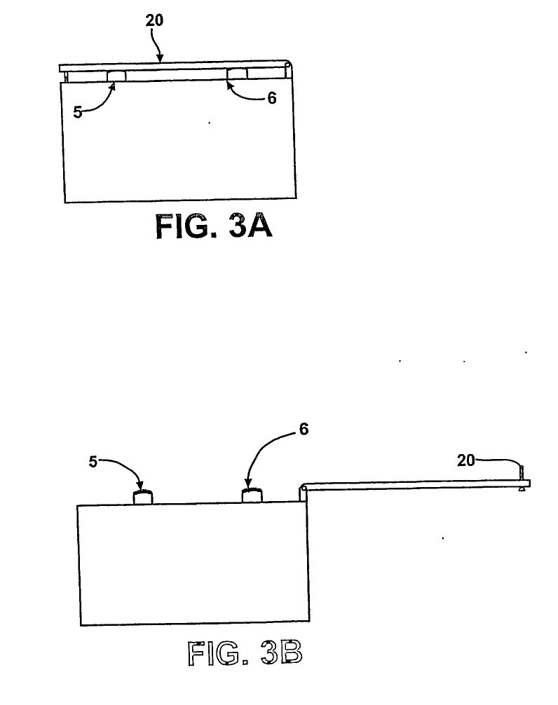

Another feature that may be added, as illustrated in FIGS. 3A and 3B, is a hinged cover 20 that may be screwed shut to prevent inadvertent operation of the Attenuator 5 and Ground Lift 6 switches depicted in FIG. 1C. This feature allows initial settings to be retained for permanent installations. The cover 20 also functions as a mounting structure, which can be conveniently attached underneath desktops or countertops.

Especially-Preferred Embodiments

Comprising Invented Direct Box System with Mixer System

In especially preferred embodiments of the present invention, key features of the invented direct box technology as described above are present to allow connection of audio generating devices, such as computer sound outputs, cassette record/playback devices or other similar devices, while also mixing these signals with a plurality of microphones. This may be accomplished by incorporating the invented “direct box” circuit, preferably having features heretofore described relating to FIG. 1, with an audio mixing circuit. The audio mixing circuit portion of the especially-preferred embodiments may be selected from those generally known in the art.

Referring now to FIG. 4, there is shown a schematic block diagram of a “matrix mixer” that is the basis of an especially preferred embodiment, in which there are typically 8 or 16 microphone input channels 25 that are input to a set of microphone amplifiers 25a, and four output channels driven by four output amplifiers 26. There can optionally be a mixed two-channel output 27 and/or a monaural output 28. These “mixed-down” outputs are synthesized by using suitable mixer amplifiers to combine the four channels first into two channels 29a, 29b and then once more into a single channel 29c. In the preferred circuit is the capability of switching any input channel selectively to one or more of the four output channels using a series of selector switches 30, preferably mounted inside the mixer enclosure to be used during set-up operations.

On the front panel of the mixer chassis, as to be easily visible, are 8 or 16 input Signal Present LEDs 31, and four output Signal Present LEDs 32. The distinctive benefit of the present invention, as applied to this mixer circuit, is realized through incorporation of Stereo (Equipment) Input 3, summing resistors 7, 8 and Room Audio switch 1, which together allow a user of the invention to sample audio content for cueing before it is played aloud in the room.

External devices may be interfaced with this circuit via the following particular inputs and outputs, for example:

1. Stereo (Equipment) Input 3: (Typically a 3.5 mm jack). A two-channel input typically sourced from a personal computer sound output, tape player output, DVD output or other similar device output.

2. Stereo Headphone Playback Output 2: (Typically a 3.5 mm jack). Allows connection to an operator's headphone set. This two-channel output is connected directly internally to the Stereo (Equipment) Input 3, such that it is always monitoring that stereo signal.

3. Balanced Switched Mic/Line Output 4: Allows connection to an existing public address (PA) system. This signal is can be silenced by the Room Audio On/Off switch 1.

4. Unbalanced Switched Playback Output 4a: (typically a 3.5 mm or ¼″ jack). This is a monaural signal that originates from the combined Stereo Equipment Input 3 signal. This signal can also be silenced by the Room Audio On/Off switch 1. The typical use for this output is in driving powered multi media speakers, i.e. powered PC speakers.

5. Mixer Microphone Inputs 25: Typically 8 or 16 each of 3.5 mm or XLR type connectors. These are the main inputs into the mixer circuit.

6. Four Channel Main Output 33: Typically a DB-9 type connector, with separate differential signals for each output channel of the mixer.

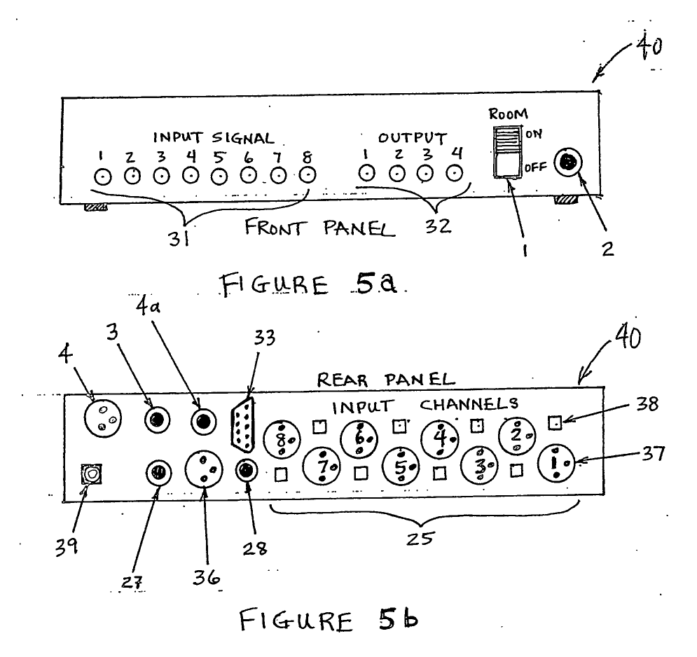

7. Alternate Main Outputs 27,28,36: Signal connectors, typically used for driving public address amplifiers or powered speakers. These connections can be balanced or unbalanced, monaural or stereo, as exemplified in FIGS. 4 and 5b, and are advantageous in instances where room audio systems have one or two channels.

Another novel feature of this especially preferred embodiment is an internal mixer playback capability, whereby Equipment Mixing Switch 34 allows the switched playback equipment signal to be fed by way of the Attenuator Pad 35 to one or more of the four Output Amplifiers 26. No other mixer is known to have this internal equipment signal mix-back capability. This feature is beneficial for the purposes of playing-back previously recorded information into a courtroom, for example, without having to use an external microphone inputs.

Referring now to FIG. 5A, the Mixer/Direct Box Chassis 40 front panel typically will incorporate 8 or 16 mixer input LEDs 31 and four channel output LEDs 32 that indicate whether a signal is present on each particular channel. Input Selector Switches 30, including the Equipment Mixing Switch 34, are typically mounted within a Mixer/Direct Box Chassis 40 and can be selectively configured at time of set-up, such that any input can be switched through to one or more output channels. Mixing, or adding of signals, occurs whenever more than one input is directed to the same output channel.

Room Audio switch 1 of the especially preferred embodiment allows the audio presenter to listen privately to the equipment input signal via Stereo Headphone Output Jack 2 to preview and/or cue audio content without broadcasting the signal over the room's audio system.

FIG. 5B depicts a view of the rear panel of the Mixer/Direct Box Chassis 40 containing the especially preferred embodiment, showing the location of various inputs and outputs of the device. Shown are the balanced Mic/Line Output 4, the Stereo (Equipment) Input 3, and Unbalanced Playback Output 4a. The 9-pin DB-9 connector 33 provides a differential four-channel Main Signal Output. On the lower left corner is a Power Input Connector 39 that accepts a power plug from a remote DC power module. Along the bottom left side of the rear panel are the Two-Channel Mixer Output 27, the Balanced Monaural Output 36 and the Unbalanced Monaural Output 28. The eight Input Connectors 25 are typically XLR type Microphone Connectors 37, but may optionally be a different type 5, such as the smaller sized example depicted at 38.

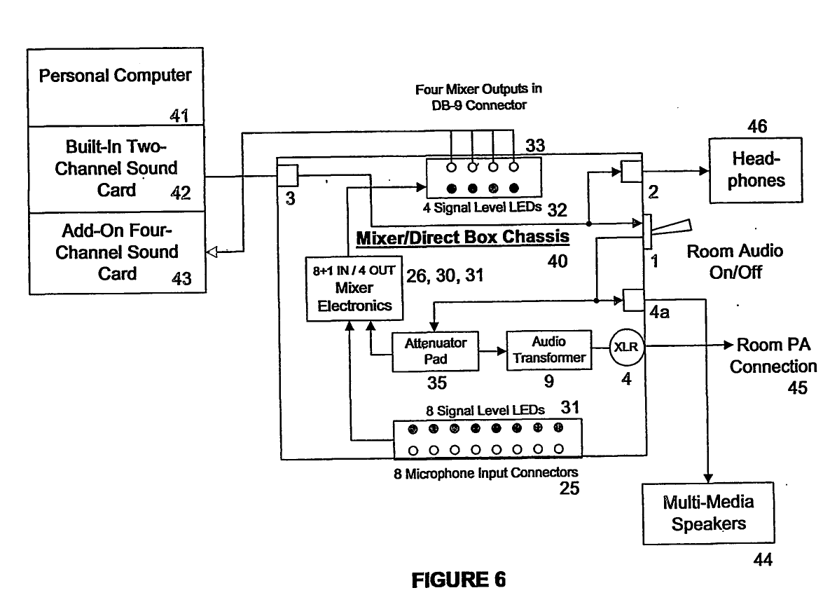

FIG. 6 is a schematic block diagram of the especially preferred embodiment, showing the external equipment and signal paths that are typically made with such a Mixer/Direct Box Chassis 40 to and from external equipment in a typical courtroom installation. A desktop or laptop Personal Computer 41 typically incorporates a sound card 42 with stereo output capability. The output from this sound card is typically fed into the Stereo (Equipment) Input 3. From there, the input signal is internally fed directly to the front panel Stereo Headphone Output Jack 2, where a connection to headphones 46 can be made. The sound card signal is also applied to one side of Room Audio switch 1, which controls the switched sound card signal feeding Attenuator Pad 35, which feeds Mixer Electronics 26, 30, 31, as shown in a single representative block in this figure. The switched sound card signal is also through Attenuator Pad 35 to Transformer 9 and provided to a Room PA system 45 via XLR Mic/Line Output connector 4.

The switched sound card signal may also be broadcast on appropriate PC Multimedia Speakers 44 through Unbalanced Switched Playback Output 4a: (typically a 3.5 mm or ¼″jack), as required for room audio listening purposes, such as via multi-media speakers at a court clerk's station or in a small meeting room that does not have a full public address system. As the switched sound card signal enters the Mixer Electronics 26, 30, 31, it is selectively routed and mixed, along with the input signals from the eight Input Connectors 25 into the four output channels and presented at DB-9 Connector 33. Input Signal LEDs 31 and Output Signal LEDs 32 show signal activity on each respective mixer channel.

The Add-On Sound Card 43 depicted in FIG. 6 will typically be a four-channel card that is plug compatible with Connector 33. It might alternately be a two-channel card, and be connected to an alternate type of output from the mixer, as was described in previous paragraphs above. This second sound card provides the fully mixed audio content to Personal Computer 41 where it can, for example, be recorded for transcription and record-keeping purposes, in order to keep complete audio courtroom records.

A beneficial application of the Mixer/Direct Box Chassis 40 is one involving courtroom transcription and court record keeping. In such a setting, typically, there are several shortcomings to using conventional equipment. One is that there is no way to conveniently play a portion of a pre-existing audio transcript back into the new court audio record, for example, when a portion of the earlier proceedings must be “re-read” to the judge or jury. A second shortcoming is that there is no straightforward method of previewing pre-existing audio transcripts before allowing them to be heard on the room PA system. Conventionally, headphones are plugged into an output connection on a transcription record/playback system or personal computer. When the headphone jack on the computer is in use, there is not an accessible jack for the room PA or multi-media speakers. A parallel jack or Y-cord does not work, as the clerk must be able to listen to the proceedings (referred to as “confidence monitoring”). Confidence monitoring has a one-half (½) second delay in the audio as it is being played back into the headphones. If this audio were to be amplified, there would be a delay and a feedback loop would be created. Therefore, it is problematic to use the headphone jack without separate control of audio.

Embodiments of the invented Mixer-Direct-Box system allow pre-existing transcripts to be mixed with additional audio content (for example, from microphone inputs) and re-recorded. This is especially beneficial, for example, when the original transcript portion is from earlier testimony that, legally, must be incorporated into the present court record. By using embodiments of the invented Mixer-Direct-Box system, a higher quality, perfectly accurate record of the court proceedings may be made, at least in part due to the “internal re-recording” feature of the preferred embodiments.

This may be easily accomplished using the especially preferred embodiment of the present invention by connecting the Stereo (Equipment) Input 3 of the Mixer/Direct Box Chassis 40 to a personal computer 41, 42 or other transcription record/playback system that outputs an original transcript audio signal. Due to the beneficial features described herein, this transcript audio signal is able to be previewed in a “preview” mode, by selecting the Room Audio switch 1 to the Off position before public address or re-recording occurs. Further, Room Audio switch 1 may be switched On to a “feed-through” mode, to allow public address and re-recording to be accomplished. Feed-through mode may include presenting an unbalanced, high impedance signal to an output jack that may be connected to speakers as needed, for example, to an output phone-jack to drive powered conventional multi media speakers. Re-recording may occur by feeding the mixed audio output signals 33 to a sound input connection on said personal computer, or optionally to a second recording device.

The advantages of this invention will be beneficial for courtroom and other public address applications due to its versatile controls, signal inputs and outputs. Although this invention has been described above with reference to particular means, materials and embodiments, it is to be understood that the invention is not limited to these disclosed particulars, but extends to all equivalents within the field of this invention and to all equivalents within the scope of the following claims. For example, a mixer might have only a single output channel and only two inputs, yet still incorporate the mixing of the equipment input internally, as described above, thereby incorporating the novel features of the invention in a markedly different configuration.

I claim:

1. In a direct box having the ability to convert a high impedance signal into a low impedance signal, the combination of said direct box with:
two output signals which are a first output signal and a second output signal; and
a switch allowing said first output signal to be connected or disconnected without interrupting said second signal.

2. A combination according to claim 1, comprising circuitry for combining left and right hand stereo signals into a single monaural audio signal.

3. A combination according to claim 1, where said first output signal is a monaural signal and said second output signal is a stereo signal.

4. A combination according to claim 1, with a switch for changing attenuation levels for said first or said second output signals.

5. A combination according to claim 1, with a ground lift switch.

6. A combination according to claim 4, wherein said switch is a three-position switch

7. A combination according to claim 6, wherein settings for said switch are 0 dB, −20 dB, and −40 dB.

8. A combination according to claim 1, further comprising:
an additional switch; and
a cover that may be secured over said ground lift switch and said attenuation level switch that prevents said switch and said additional switch from being manipulated while said cover is in place.

9. A combination according to claim 8, wherein said additional switch is a switch for changing attenuation levels for said first or said second output signals.

10. A combination according to claim 8, wherein said additional switch is a ground lift switch.

11. A combination according to claim 9, wherein said switch is a three-position switch.

12. A combination according to claim 6, wherein settings for said switch are 0 dB, −20 dB, and −40 dB.

13. In a direct box having the ability to convert a high impedance signal into a low impedance signal, the combination of said direct box with:
a plate that covers a switch on said direct box such that said switch cannot be moved while said cover is in place.

14. A combination according to claim 13, where said switch is a switch for changing attenuation levels for the output signal.

15. A combination according to claim 13; where said switch is a ground lift switch.

16. A combination according to claim 14, wherein said switch is a three-position switch.

17. A combination according to claim 6, wherein settings for said switch are 0 dB, −20 dB, and −40 dB.

18. In a mixer electronic circuit having the ability to mix multiple audio inputs into one or more outputs, the combination of said mixer electronic circuit with a direct box circuit comprising:
an audio input connection from an external source that provides a direct audio signal, said direct audio signal being provided to a first external output; and
an internal mixer input that routes said direct audio signal internally to said mixer electronic circuit;
an audio transformer that converts said direct audio signal from a high-impedance signal into a low-impedance audio signal provided to a second external output; and
a switch allowing said direct audio signal to be connected and disconnected from said internal mixer input and from said audio transformer.

19. The combination of claim 18, where said first external output connects to a set of headphones or headset.

20. The combination of claim 18, where said audio input connection connects to an external personal computer sound port.

21. The combination of claim 18, where said audio input connection connects to an external record/playback device.

22. The combination of claim 18, where said second external output connects to a room public address system.

23. The combination of claim 18, where said second external output connector is an XLR connector.

24. The combination of claim 18, where said second external output connector is an unbalanced phone-jack connector.

25. The combination of claim 18, where said direct audio signal is fed through an attenuator pad to said mixer electronic circuit.

26. A method by which pre-existing transcripts can be mixed with additional audio content and re-recorded, the method comprising:
providing a mixer-direct-box combination circuit;
providing an original transcript audio signal, as read from a transcription device;
feeding said transcript audio signal to an audio input connection of said mixer-direct-box combination circuit;
switching said transcript audio signal between a preview mode and a feed-through mode;
wherein said preview mode comprises feeding said transcript audio signal solely to a first external output for listening with a set of headphones or headset, and
wherein said feed-through mode comprises feeding said transcript audio signal to an internal mixer input that routes said transcript audio signal internally to a mixer electronic circuit which is output to a sound card input on said transcription device or to a second transcription device, and said feed-through mode further comprises feeding said transcript audio signal to a room public address system.

27. A method according to claim 26, wherein the second transcription device is a magnetic tape-based transcription system.

28. A method according to claim 26, wherein the second transcription device is a magnetic personal computer-based transcription system.

29. A method according to claim 26, wherein the feed-through mode further comprises presenting said transcript audio signal to an unbalanced output phone-jack adapted for connection to external speakers.

30. A method according to claim 29, wherein said external speakers are multi-media speakers.
